(19) United States
(12) Patent Application Publication
(10) Pub. No.: US 2014/0024400 A1
(43) Pub. Date: Jan. 23, 2014

(54) MANAGEMENT OF MOBILE DEVICE ORIGINATED MEETINGS

(71) Applicants: Seok Tae KANG, Seoul (KR); Yu Kyoung Kang, Seoul (KR); Myoung Soo Kang, Seoul (KR)

(72) Inventors: Seok Tae KANG, Seoul (KR); Yu Kyoung Kang, Seoul (KR); Myoung Soo Kang, Seoul (KR)

(73) Assignee: LG CNS CO., LTD., Seoul (KR)

(21) Appl. No.: 13/553,862

(22) Filed: Jul. 20, 2012

(51) Int. Cl. H04W 4/12

(52) U.S. Cl. CPC H04W 4/12
USPC 455/466

(57) ABSTRACT

Embodiments described herein provide approaches for managing mobile device originated meetings involving multiple mobile device users belonging to a group. Specifically, a meeting request is sent to the mobile device of each member of the group, and subsequent recognition of responding and non-responding members is established. Those members of the group failing to respond within a predetermined time period are sent a secondary meeting request in an attempt to solicit a response. An optimal meeting request and/or response message type is selected for each mobile device belonging to each member of the group. As such, interoperability between different devices and meeting systems is maintained, while also allowing those users sharing the same meeting system platform to communicate via push-notification internet-based messages, thereby decreasing reliance on cellular based short messaging service (SMS) messages.

### BACKGROUND

1. Technical Field

This invention relates generally to electronic meeting notifications, and more specifically, to effective management of a mobile device originated meetings.

2. Related Art

Scheduling of meeting requests and acceptance of meeting requests has traditionally been done by desktop computers or laptop computers which are fitted with a hard disk drive or other high capacity memory mechanisms, or by low intelligence terminals which are permanently attached to a server or other similar computer which, itself, contains a high capacity storage device. However, with the increased proliferation of mobile devices (e.g., smart phones, tablet computers, cellular phones, personal digital assistants, etc.), the scheduling and acceptance of meeting requests is more commonly being implemented via mobile devices.

A number of obstacles present themselves when attempting to provide a user with the capability of generating and/or accepting a meeting request from a mobile device. For example, a user of the mobile device may be inundated with a large number of e-mail messages, text messages, etc., and may overlook a meeting request. Furthermore, with the wide variety of mobile devices, operating systems, and cellular/provider requirements, a meeting request generated by one mobile device may be incompatible with scheduling applications of another mobile device. Still furthermore, an increased number of meeting requests and responses communicated via SMS will increase each mobile device user's messaging use, thereby potentially resulting in increased fees.

Korean patent application 10-2004-0072276 describes a gathering or meeting announcement, but does not include a notification function among group members, nor does it include an attendee's response.

U.S. Pat. No. 7,869,941 describes an approach in which location and appointment times are compared to determine if, based on a current location, whether the travel time exceeds the amount of time remaining until the appointment. If it is determined that the travel time exceeds the amount of time remaining, a communication is sent.

U.S. Pat. No. 7,984,378 describes a meeting management application that permits the manipulation of meetings by groups. The meeting management application incorporates or is associated with a scheduling application for receiving and maintaining meeting information. The meeting management application may additionally include or be associated with a grouping application. The grouping application may permit the creation of groups of meetings having one or more specified items of associated information. Once a group of meetings is defined, modifications to information associated with each meeting within the group can be applied to the included meetings globally.

U.S. Pat. No. 8,073,614 describes a meeting notification and automatic modification service, which, based on geographic information, the system may identify a route extending from the geographic location of a first participant to the geographic location of the appointment, and may identify a travel time associated with the route. Based on the travel time and the appointment time, the system may determine whether the first participant is estimated to arrive at the appointment on time and, based on the determination, the system may send a message to participants of the appointment or dynamically reschedule the appointment.

Therefore, what is needed is a meeting management approach for a mobile device that addresses at least one of the deficiencies of the current art.

### SUMMARY

In general, embodiments described herein provide approaches for managing mobile device originated meetings involving multiple mobile device users belonging to a group. Specifically, a meeting request is sent to the mobile device of each member of the group, and subsequent recognition of responding and non-responding members is established. Those members of the group failing to respond within a predetermined time period are sent a secondary meeting request in an attempt to solicit a response. An optimal meeting request and/or response message type is selected for each mobile device belonging to each member of the group. As such, interoperability between different devices and meeting systems is maintained, while also allowing those users sharing the same meeting system platform to communicate via push-notification internet-based messages, thereby decreasing reliance on cellular based short messaging service (SMS) messages.

One aspect of the present invention includes a method for managing mobile device originated meetings, comprising the computer-implemented steps of: transmitting a meeting request to a mobile device of each member of a group; receiving a response to the meeting request from a set of members from the group; determining a set of members from the group who have not responded to the meeting request; and transmitting the meeting request to the mobile device of each member of the group who has not responded to the meeting request.

Another aspect of the present invention provides a system for managing mobile device originated meetings, the system comprising: a memory medium comprising instructions; a bus coupled to the memory medium; and a processor coupled to a management system via the bus that when executing the instructions causes the system to: transmit a meeting request to a mobile device of each member of a group; receive a response to the meeting request from a set of members from the group; determine a set of members from the group who have not responded to the meeting request; and transmit the meeting request to the mobile device of each member of the group who has not responded to the meeting request.

Another aspect of the present invention provides computer-readable storage medium storing computer instructions, which when executed, enables a computer system to provide management of mobile device originated meetings, the computer instructions comprising: transmitting a meeting request to a mobile device of each member of a group; receiving a response to the meeting request from a set of members from the group; determining a set of members from the group who have not responded to the meeting request; and transmitting the meeting request to the mobile device of each member of the group who has not responded to the meeting request.

Another aspect of the present invention provides a method for managing mobile device originated meetings, the method comprising: transmitting, using a computer system, a meeting request to a mobile device of each member of a group; receiving, using the computer system, a response to the meeting request from a set of members from the group; determining, using the computer system, a set of members from the group who have not responded to the meeting request; and transmitting, using the computer system, the meeting request to the mobile device of each member of the group who has not responded to the meeting request.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a system diagram according to illustrative embodiments.

FIG. 2 shows a group manager according to illustrative embodiments.

FIG. 3 shows meeting management server according to illustrative embodiments.

FIG. 4 shows an operational flow chart of the meeting management server according to illustrative embodiments.

FIG. 5 shows a group management flow chart of the server according to illustrative embodiments.

FIGS. 6-8 show a flow chart of an exemplary system according to illustrative embodiments.

FIG. 9 shows an exemplary computer implementation according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments now will be described more fully herein with reference to the accompanying drawings, in which exemplary embodiments are shown. Embodiments described herein provide approaches for managing mobile device originated meetings involving multiple mobile device users belonging to a group. Specifically, a meeting request is sent to the mobile device of each member of the group, and subsequent recognition of responding and non-responding members is established. Those members of the group failing to respond within a predetermined time period are sent a secondary meeting request in an attempt to solicit a response. An optimal meeting request and/or response message type is selected for each mobile device belonging to each member of the group. As such, interoperability between different devices and meeting systems is maintained, while also allowing those users sharing the same meeting system platform to communicate via push-notification internet-based messages, thereby decreasing reliance on cellular based short messaging service (SMS) messages.

It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

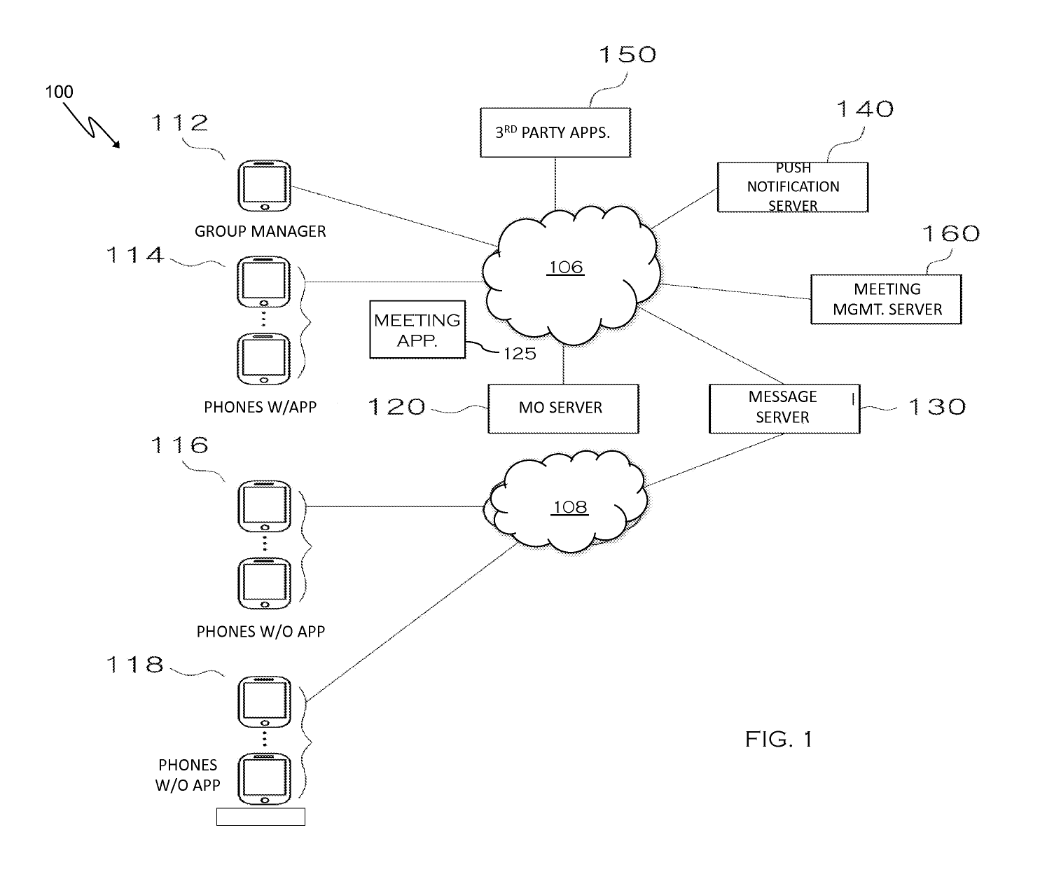

With reference now to the figures, FIG. 1 depicts a system 100 that facilitates managing mobile device originated meetings. System 100 includes a group manager 112, e.g., an originator of a meeting request, a set of smart phones having a meeting application 125 installed thereon 114, a set of phones operating without the meeting application installed thereon 116, a set of “feature phones” 118, e.g., picture phones 118, mobile originated (MO) server 120, a cellular message server 130, a push notification server 140, third-party applications 150, and a meeting management server 160.

In one embodiment, group manager 112, meeting application enabled smart phones 114, MO server 120, cellular message server 130, push-notification server 140, third-party applications 150, and management server 160 are all connected via an internet-based network 106. Network 106 may include connections, such as wire, wireless communication links, or fiber optic cables. System 100 also may be implemented as a number of different types of networks, such as for example, an intranet, a local area network (LAN), or a wide area network (WAN).

Meeting application enabled smart phones 114 may send and receive push-notification messages via internet-based network 106. Push notification messages are communicated through a constantly-open IP connection to forward notifications from various servers to enabled devices. Such notifications may include badges, sounds, custom text alerts, and, in exemplary embodiments, meeting requests. Push notifications provide a way for the meeting application to send information to enabled devices even when an application isn't currently in use. For example, if meeting application 125 is installed on meeting enabled smart phones 114, MO server 120 can send a meeting request even if meeting application 125 isn't currently running. In one embodiment, the meeting notification can send a request that, when clicked/selected/touched, etc., directs the user back to meeting application 125 to enable the user to activate meeting application 125 and provide a response to the request.

Non-meeting application enabled smart phones 116, as well as non-meeting enabled feature phones 118, are connected through a cellular network 108 to cellular message server 130. Cellular network 108 comprises a radio network distributed over land areas called cells, each served by at least one fixed-location transceiver, known as a cell site or base station. In a cellular network, each cell uses a different set of frequencies from neighboring cells, to avoid interference and provide guaranteed bandwidth within each cell. When joined together these cells provide radio coverage over a wide geographic area. This enables a large number of portable transceivers (e.g., mobile phones, pagers, etc.) to communicate with each other and with fixed transceivers and telephones anywhere in the network, via base stations, even if some of the transceivers are moving through more than one cell during transmission.

Non-meeting enabled phones 116 and 118 are required to use cellular network 108, as MO server 120 is not connected to or operational on these devices. In this case, a meeting request is sent to desired group of members using a group identifier (e.g., 015-XXXX-XXXX) through the cellular message server 130. Cellular messages are communicated to non-meeting enabled phones 116 and 118 via meeting management server 160, network 106, message server 130, and cellular network 108.

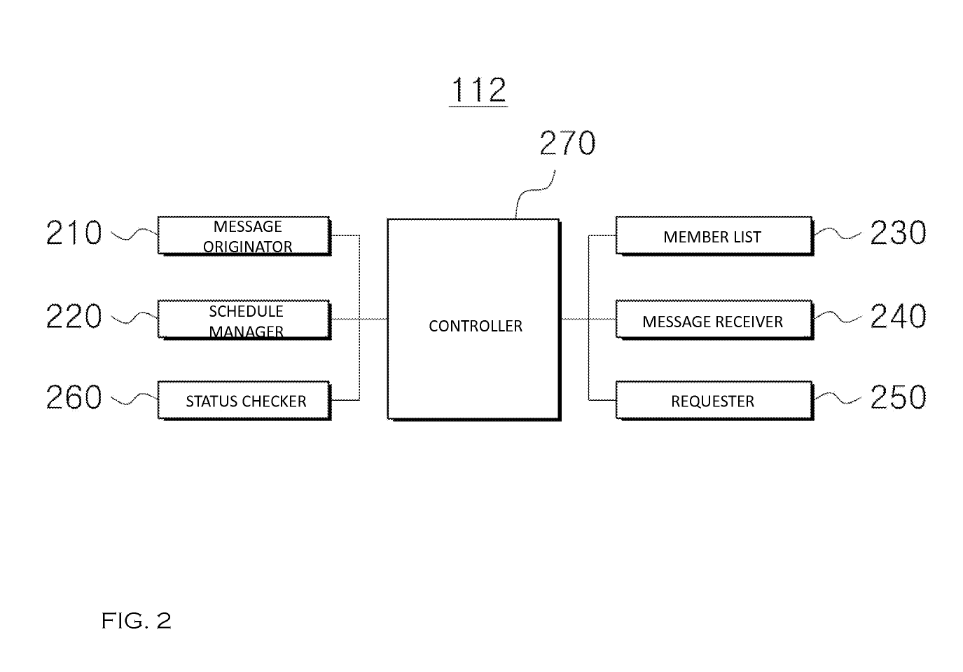

Referring now to FIG. 2, an exemplary operation of group manager 112 will be described in further detail. As shown, group manager 112 operates with a message originator 210, a schedule manager 220, a member List 230, a message receiver 240, a response second re-requester 250, a response status checker 260, and a controller 270. During operation, message originator 210 indicates a desire, which is received at controller 270, to schedule a meeting with a group of members (i.e., member list 230). Schedule manager 220 configures the meeting request on a calendar of the mobile device of message originator 210, and enables configuration with member list 230. In one embodiment, member list 230 may be generated from address book on the mobile device of message originator 210. Once member list 230 is established, the meeting request is then transmitted to the mobile device of each member on member list 230. After the message is received, a response to the meeting request from a sub-set of members of the group is received at message receiver 240. Response status checker 260 determines a set of members from member list 230 who have not yet responded to the meeting request. For those members, response second re-requester 250 transmits another (e.g., duplicate, or more urgent appearing) meeting request to the mobile device of each member of member list 230 who has not responded to the meeting request.

Given the difference between meeting-application enabled and non-meeting application enabled mobile devices, a number of message communication configurations are possible. Therefore, during operation, it is necessary to first determine an operating system and type of mobile device used by each member of the group. Based on this, a method of communication configured for each type of mobile device must also be determined. As noted above, the group typically comprises members using either a smart phone enabled with a meeting application 114 used to generate the meeting request, a smart phone operating without the meeting application 116 used to generate the meeting request, or a picture phone operating without the meeting application 118 used to generate the meeting request. Depending on this determination, embodiments of the invention enable push-notification internet-based communication for members of the group using a smart phone enabled with the meeting application used to generate the meeting request, and enable cellular-based communication for each of: members of the group using a smart phone operating without the meeting application used to generate the meeting request, and members of the group using a picture phone operating without the meeting application used to generate the meeting request. Meeting requests are then optimizing for each type of mobile device, and transmitted based on the method of communication configured for each type of mobile device.

In one embodiment, meeting request messages sent by group manager 112 are sent via message server 130 to meeting application enabled (i.e., installed) smart phone 114, non-meeting application enabled (i.e., uninstalled) phone 116, or non-meeting enabled application picture phone 118 through a short message service center (SMSC).

In another embodiment, push notification server 140 can send an internet-based message. For an example, non-meeting enabled application picture phone 118 may be the originator of the meeting request, and sends a message to the message server 130. Then the message server 130 relays the message to MO server 120. MO server 120 sends the meeting information to meeting management server 160. The meeting management server sends out the meeting information through message server 130 or push server 140 to the other members of the group.

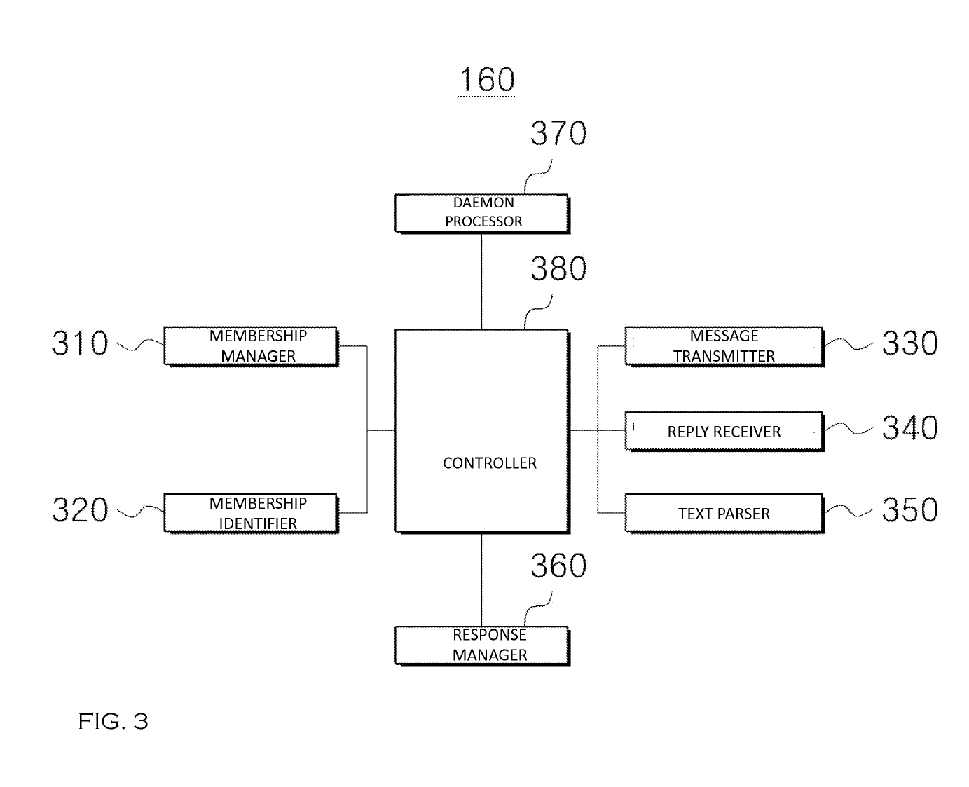

Referring now to FIG. 3, in another embodiment, meeting application enabled smart phone 114 can send a message to the meeting management server 160. Then meeting management server 160 can relay the message to the other clients thru the message server 130 or the push server 140 (FIG. 1). In this embodiment, meeting management server 160 comprises a controller 380 operating with a membership manager 310 for managing meeting application 125 (FIG. 1.) and determining the communication method for each mobile device, a membership identifier 320 for identifying members of the group using meeting application enabled phones, a message transmitter 330 for sending meeting requests to the group, a message reply receiver 340 and response manager 360 for receiving and managing responses to meeting requests, and a text parser 350. In one embodiment, text parser 350 is configured to answer a meeting request using a predefined sentence structure based on the question sentence. For example, text parser 350 can express the response with a parse tree. The predefined sentence structure reply can be “attend” or “attend!” either of which can be interpreted as attend.

Meeting management server 160 further comprises a daemon processor 370 for implementing daemon programs (i.e., programs that are not invoked explicitly, but lay dormant waiting for some condition(s) to occur.) Daemon processor 370 can send a message to one or more members without involvement from meeting management server 160. In exemplary embodiments, daemon processor 370 sends a message to one or more members of the group who have yet to respond to the meeting request. Daemon processor 370 can determine a list of unanswered members based on the reply status of the response manager 360. Daemon processor 370 determines the communication time interval with the unanswered members to wait to push out the meeting request messages again based on a mathematical determination.

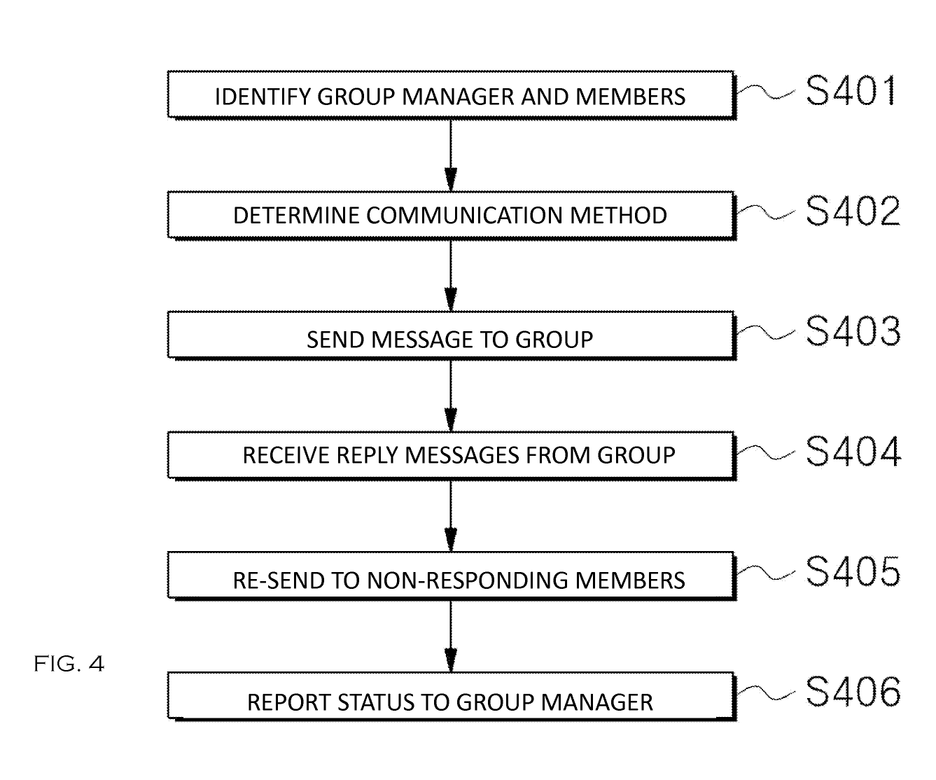

Referring now to FIG. 4, operation of meeting management server 160 of FIG. 3 will be described in greater detail according to the following process flow. In step S401, meeting management server 160 identifies the group manager 112 and members of the group using membership identifier 320. At S402, membership manager 310 determines the communication method for all of the following: the smart phone(s) enabled with a meeting application 114 used to generate the meeting request, the smart phone(s) operating without the meeting application 116 used to generate the meeting request, and the picture phone(s) operating without the meeting application 118 used to generate the meeting request. At S403, message transmitter 330 sends a message (e.g., a meeting request) to the group via cellular message server 130 or message push notification server 140. At S404 message reply receiver 340 receives a reply message from one or more members of the group. For those members who have yet to reply, message transmitter 330 re-sends a message (e.g., a duplicate or more urgent appearing meeting request) to those members at S405. Daemon processor 370 determines the communication time interval with the unanswered members to push out the meeting request messages based on the following mathematical determination, wherein:

N of time interval may be adjusted;

Among the N number of time interval i (N>i>1) is defined by the equation:

$${TI}_{i} = {TI}_{i - 1} - C \times \frac{{TI}_{i - 1}}{{R}_{FT}}$$

Here, C is a constant value, and R_{FT} is determined by group manager 112. It determines the remaining time. TI₀ is greater then 0 and smaller then R_{FT}. TI₀ can be predetermined. When the time is value is satisfied, meeting management server 160 reports the status to group manager 112 at S406.

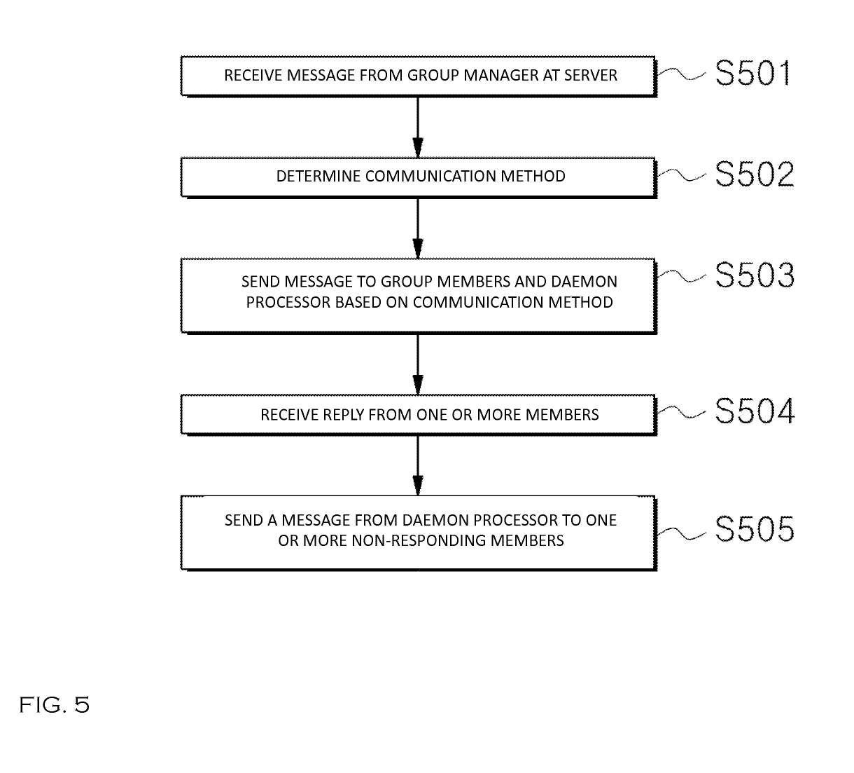

Referring now to FIG. 5, a flow chart of meeting management server 160 according to illustrative embodiments will be described in greater detail. As shown, at S501, meeting management server 160 receives a message from the group manager 112. At S502 membership manager 310 determines a method of communication. At S503, the message receiver 330 sends the message to one or more members, and sends a message to daemon processor 370. At S504, the message receiver 340 receives a reply from one or more members, and sends the decision (accept, deny, etc.) to reply manager 360 based on the received message. At S505, daemon processor 370 sends a message to one or more unanswered members. Daemon processor 370 can determine a list of unanswered members based on the reply status of reply manager 360. Daemon processor 370 again uses the following mathematical formula to determine the communication time interval with the unanswered members to push out the messages:

$${TI}_{i} = {TI}_{i - 1} - C \times \frac{{TI}_{i - 1}}{{R}_{FT}}$$

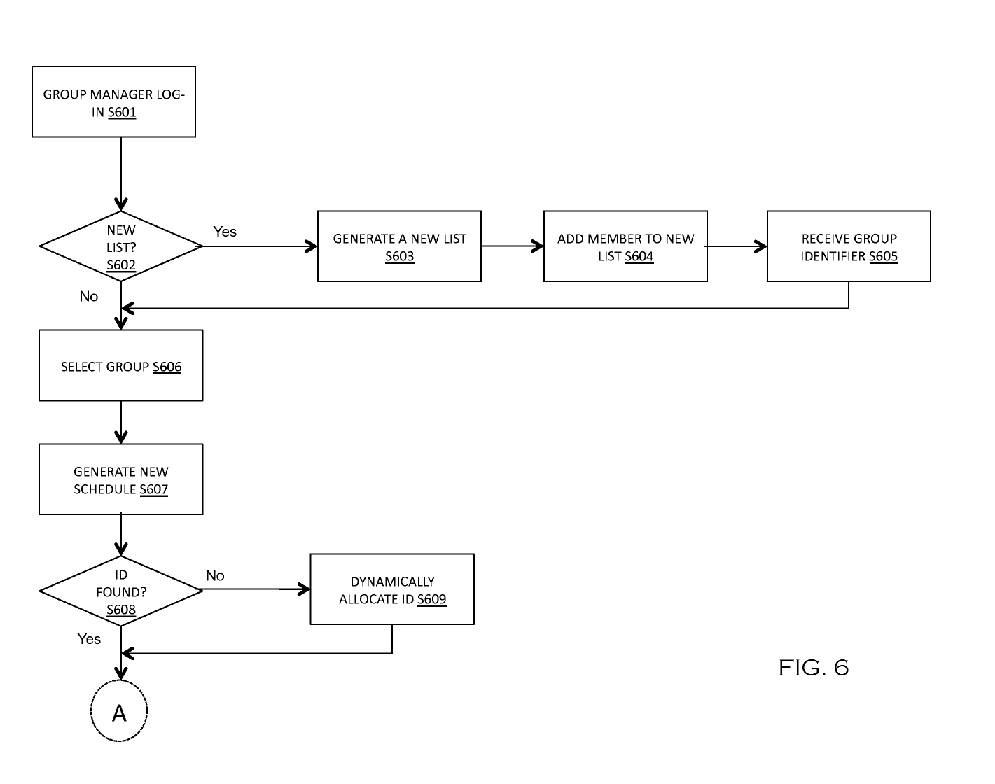

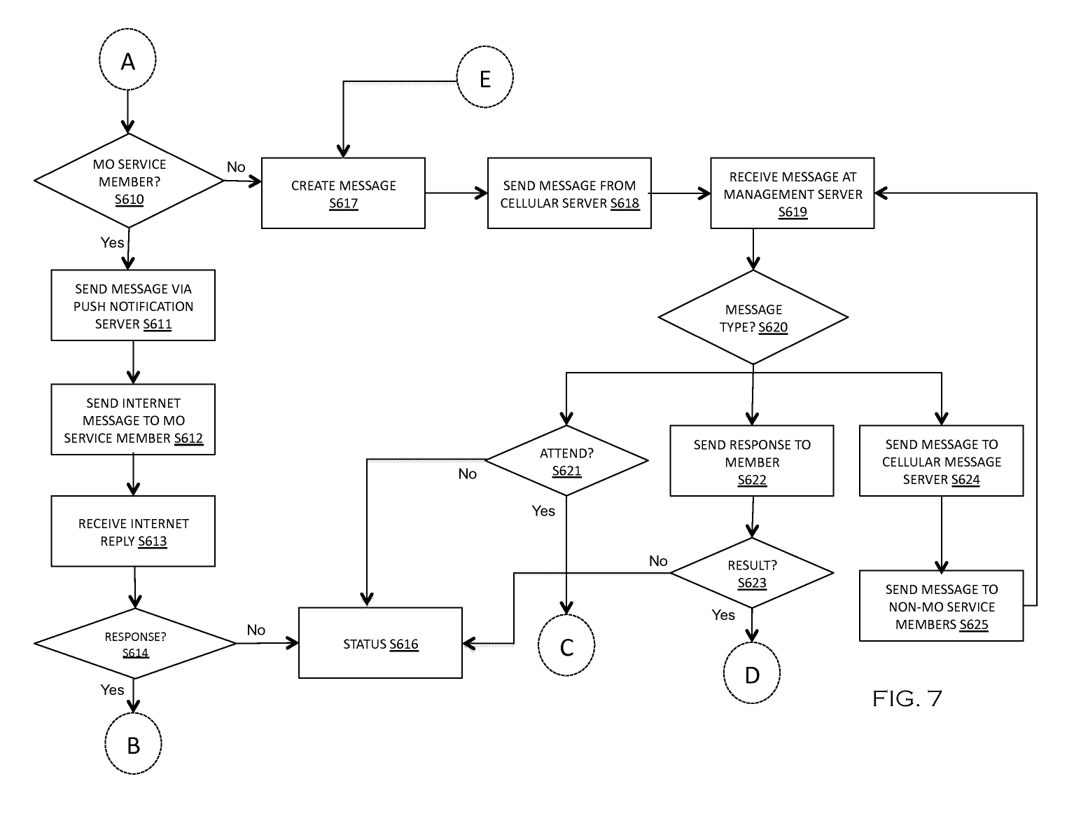

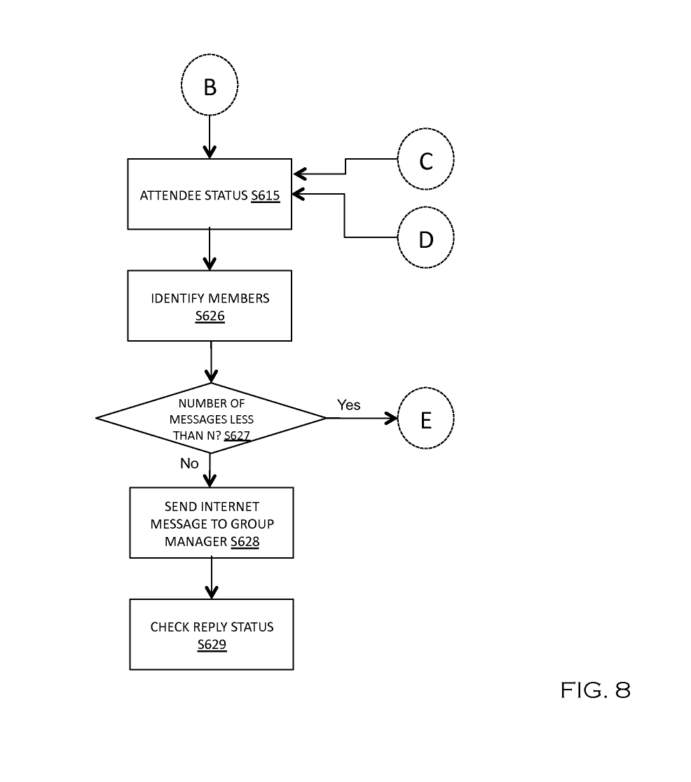

Referring now to FIGS. 6-8, a flow chart of an exemplary system according to illustrative embodiments is described in greater detail. As shown, group manager 112 logs in at S601, and searches the group list at S602. If the manager needs a new list, group manager 112 generates a new list at S603. Group manager 112 adds a member to a new list at S604 and sends it to meeting management server 160, and the registration is completed. At S605, group manager 112 receives a group identifier from meeting management server 160. For example, the group identification may be 015-XXXX-XXXX and a member of MO service. Group Manager 112 selects the group at S606, and a new schedule is generated at S607. The new schedule includes a calendar title, subjects start time, end time, the meeting place, the schedule information, etc.

Group manager 112 desiring to schedule a new meeting can send a query message to meeting management server 160 for registration. Intended recipients can receive messages through the meeting management server 160 via an identifier. That is, group manager 112 requests to assign an identifier for the new meeting schedule to management server 160. If the request at S608 to management 160 for the corresponding calendar schedule identifier is taken, one is dynamically allocated at S609. Group Manager 112 can select the allocation of a certain identifier, and the meeting management server 160 can allocate the date and time identifier when it is requested.

Next, at S610, meeting management server 160 determines whether one or more group members receiving the message is a MO service member (i.e., a members who has installed the meeting application on his/her smart phone (114), or a non-MO service member (i.e. uninstalled meeting application smart phone 116 members or uninstalled meeting application feature phone 118 member. When the members are recognized as the MO service members, then the meeting management server 160 requests to the push message server 140 to send out a message at S611. The push message server 140 sends an Internet message to the MO service member smart phone 114 at step S612. The Internet message and the sender can be linked by the group identifier or data identifier. The meeting management server 160 receives the Internet reply at S613, and it is decided whether to attend, reject or provide no reply at S614. If an “attend” reply is received, then meeting management server 160 updates the attendee list at S615. If an “absent” reply is received, then meeting management server 160 updates the absent list at S616.

In the case that the member is non-MO service member (i.e. uninstalled meeting application smart phone members 116 or uninstalled meeting application feature phone 118 member), then a message is created at S617 and meeting management server 160 sends the message to cellular message server 130 to send a question message at S618. Meeting management server 160 receives the reply message from the non-MO service member mobile device at S619, and meeting management server 160 examines the message type at S620. The message formats are as follows: (i) attend or not-attend indication message; (ii): added predefined message on message format (i); or (iii): user provided message. Meeting management server 160 also determines whether the reply includes any additional messages.

Meeting management server 160 determines whether the member will attend if the reply is message format (i) at S621. If the reply is to attend, then meeting management server 160 updates the reply status of the phone owner (e.g., uninstalled smart phone 116 or featured phone 118). If the reply is “absent”, meeting management server 160 updates the reply status to “absent” at S616. If the message format is (ii), then meeting management server 160 sends the attached message to group manager 112 and at least one member at S622. Next, meeting management server 160 determines the result based on the reply message step at S623. If the replay includes “attend”, then meeting management server 160 updates the reply status at S615. If the reply includes “absent”, then meeting management server 160 updates the status to absent at S616. Finally, If the reply format is (iii) type, then meeting management server 160 sends a message to cellular message server 130 at S624. Cellular message server 130 then sends the message to non-MO service member devices 116 and 118 at S625.

Next communication is made with those members failing to provide a response. As shown, meeting management server 160 identifies these members at S626. The server can extract the no reply list of members after the preset time period. At S627, it is determined if the number of messages sent is less than N. If so, then meeting management server 160 sends an inquiry message to one or more members and repeats the steps at S617 and S627. Meeting management server 160 can resend the message to the no reply members.

If at S627 it is determined that the number is over N numbers, then meeting management server 160 can send a request to the push notification server 140 to stop and send a message to group manager 112 via an internet message at S628. Group manager 112 uses an application and checks at least one member's reply status at S629. Group manager 112 checks the status and determines whether the meeting will be held or cancelled and sends the result to meeting management server 160. When the meeting is fixed, meeting management server 160 can send the periodic notification to the members.

In another embodiment, group manager 112, through the application of at least one member, can check the status of the response. Statuses of a response, attending, not attending, no answer, etc. can be displayed by category. Group manager 112 can send a message by selecting a name or picture, or by selecting a member's icon to make phone calls or text messages.

It can be appreciated that the approaches disclosed herein can be used within a computer system to manage mobile device originated meetings. To this extent, the deployment can comprise one or more of (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary embodiments may be described in the general context of computer-executable instructions, such as program modules, being executed by a computer. Generally, program modules include routines, programs, people, components, logic, data structures, and so on, which perform particular tasks or implement particular abstract data types. An exemplary computer system may be practiced in distributed computing environments where tasks are performed by remote processing devices that are linked through a communications network. In a distributed computing environment, program modules may be located in both local and remote computer storage media including memory storage devices.

The flowcharts of FIGS. 4-8 illustrate the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, as will be described herein, systems/components may also be implemented as a combination of software and one or more hardware devices. For example, control 270 and controller 380, may be embodied in the combination of a software executable code stored on a memory medium (e.g., memory storage device). In a further example, a system or component may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

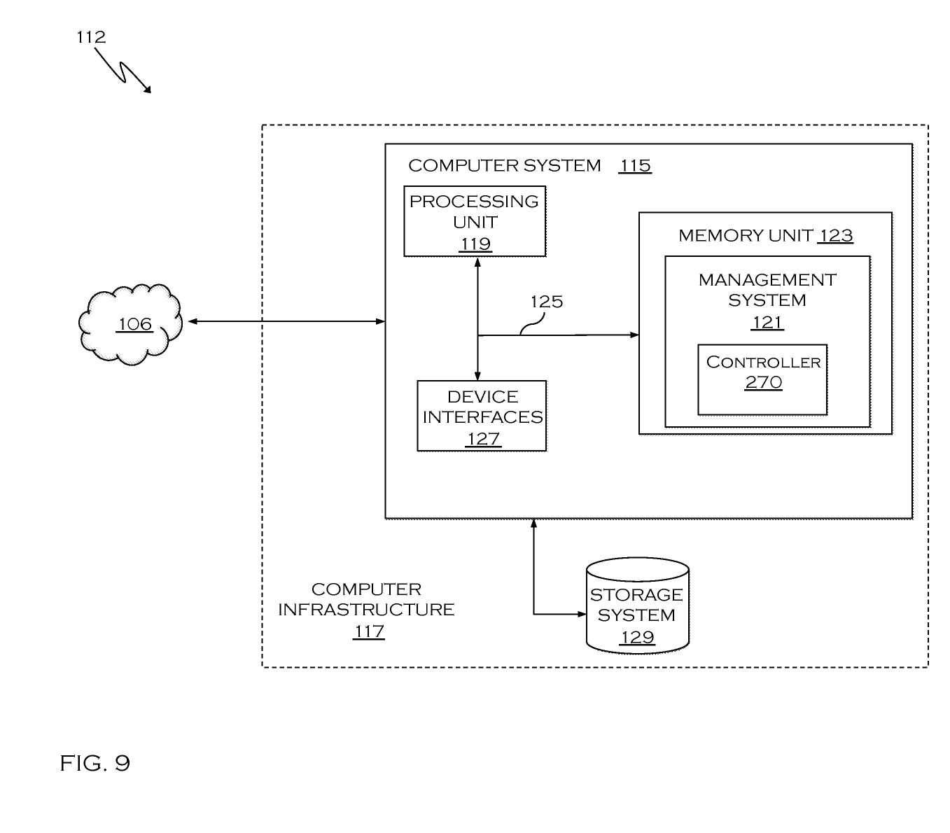

Referring now to FIG. 9, a computer implementation of group manager 112 operating via a computer system 115 deployed within a computer infrastructure 117 will be described in greater detail. This is intended to demonstrate, among other things, that embodiments can be implemented within a network environment 106 (e.g., the Internet, a wide area network (WAN), a local area network (LAN), a virtual private network (VPN), etc.), or on a stand-alone computer system. Still yet, computer infrastructure 117 is intended to demonstrate that some or all of the components of group manager 112 could be deployed, managed, serviced, etc., by a service provider who offers to implement, deploy, and/or perform the functions of the present invention for others.

Computer system 115 is intended to represent any type of computer system that may be implemented in deploying/realizing the teachings recited herein. In this particular example, computer system 115 represents an illustrative system for providing managing mobile device originated meetings. It should be understood that any other computers implemented under various embodiments may have different components/software, but will perform similar functions. As shown, computer system 115 includes a processing unit 119 capable of operating with a management system 121, including controller 270, stored in a memory unit 123 to management of mobile device originated meetings. Also shown is a bus 125, and device interfaces 127.

Processing unit 119 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 119 communicates with management system 121. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 119 executes computer program code, such as program code for operating management system 121, which is stored in memory unit 123 and/or storage system 129. While executing computer program code, processing unit 119 can read and/or write data to/from memory unit 121 and storage system 129. Storage system 129 can include VCRs, DVRs, RAID arrays, USB hard drives, optical disk recorders, flash storage devices, and/or any other data processing and storage elements for storing and/or processing data. Although not shown, computer system 115 could also include I/O interfaces that communicate with one or more hardware components of computer infrastructure 117 that enable a user to interact with computer system 115 (e.g., a keyboard, a display, camera, etc.).

In one embodiment, an implementation of exemplary computer system 115 may be stored on or transmitted across some form of computer-readable storage medium. Computer-readable storage medium can be media that can be accessed by a computer. “Computer-readable storage medium” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. “Communication medium” typically embodies computer readable instructions, data structures, and program modules. Communication media also includes any information delivery media.

It is apparent that there has been provided an approach for structured communication for managing mobile device originated meetings. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for managing mobile device originated meetings, the method comprising the computer-implemented steps of:
transmitting a meeting request to a mobile device of each member of a group;
receiving a response to the meeting request from a set of members from the group;
determining a set of members from the group who have not responded to the meeting request; and
transmitting the meeting request to the mobile device of each member of the group who has not responded to the meeting request.

2. The method according to claim 1, further comprising the computer-implemented steps of:
determining an operating system and type of mobile device used by each member of the group; and
optimizing the meeting request for each type of mobile device.

3. The method according to claim 2, the computer implemented step of optimizing further comprising:
determining a method of communication configured for each type of mobile device; and
transmitting the meeting request based on the method of communication configured for each type of mobile device.

4. The method according to claim 2, the computer-implemented step of determining further comprising defining the operating system and type of mobile device used by each member of the group as at least one of the following: a smart phone enabled with a meeting application used to generate the meeting request, a smart phone operating without the meeting application used to generate the meeting request, and a picture phone operating without the meeting application used to generate the meeting request.

5. The method according to claim 4, further comprising:
enabling push-notification internet-based communication for members of the group using a smart phone enabled with the meeting application used to generate the meeting request;
and enabling cellular-based communication for each of: members of the group using a smart phone operating without the meeting application used to generate the meeting request, and members of the group using a picture phone operating without the meeting application used to generate the meeting request.

6. A system for managing mobile device originated meetings, the system comprising:
a memory medium comprising instructions;
a bus coupled to the memory medium; and
a processor coupled to a management system via the bus that when executing instructions causes the system to:
transmit a meeting request to a mobile device of each member of a group;
receive a response to the meeting request from a set of members from the group;
determine a set of members from the group who have not responded to the meeting request; and
transmit the meeting request to the mobile device of each member of the group who has not responded to the meeting request.

7. The system according to claim 6, further comprising instructions causing the system to:
determine an operating system and type of mobile device used by each member of the group; and
optimize the meeting request for each type of mobile device.

8. The system according to claim 7, the instructions causing the system to optimize the meeting request further comprising instructions causing the system to:
determine a method of communication configured for each type of mobile device; and
transmit the meeting request based on the method of communication configured for each type of mobile device.

9. The system according to claim 7, the instructions causing the system to determine the method of communication further comprising instructions causing the system to define the operating system and type of mobile device used by each member of the group as at least one of the following: a smart phone enabled with a meeting application used to generate the meeting request, a smart phone operating without the meeting application used to generate the meeting request, and a picture phone operating without the meeting application used to generate the meeting request.

10. The system according to claim 9, further comprising computer instuctions causing the system to:
enable push-notification internet-based communication for members of the group using a smart phone enabled with the meeting application used to generate the meeting request;
and enable cellular-based communication for each of: members of the group using a smart phone operating without the meeting application used to generate the meeting request, and members of the group using a picture phone operating without the meeting application used to generate the meeting request.

11. A computer-readable storage medium storing computer instructions, which when executed, enables a computer system to provide management of mobile device originated meetings, the computer instructions comprising:
transmitting a meeting request to a mobile device of each member of a group;
receiving a response to the meeting request from a set of members from the group;
determining a set of members from the group who have not responded to the meeting request; and
transmitting the meeting request to the mobile device of each member of the group who has not responded to the meeting request.

12. The computer-readable storage medium according to claim 11, the computer instructions further comprising:
determining an operating system and type of mobile device used by each member of the group; and
optimizing the meeting request for each type of mobile device.

13. The computer-readable storage medium according to claim 12, the computer instructions for optimizing further comprising:
determining a method of communication configured for each type of mobile device; and
transmitting the meeting request based on the method of communication configured for each type of mobile device.

14. The computer-readable storage medium according to claim 12, the computer instructions for determining further comprising defining the operating system and type of mobile device used by each member of the group as at least one of the following: a smart phone enabled with a meeting application used to generate the meeting request, a smart phone operating without the meeting application used to generate the meeting request, and a picture phone operating without the meeting application used to generate the meeting request.

15. The computer-readable storage medium according to claim 14, further comprising computer instructions for:
enabling push-notification internet-based communication for members of the group using a smart phone enabled with the meeting application used to generate the meeting request; and
enabling cellular-based communication for each of: members of the group using a smart phone operating without the meeting application used to generate the meeting request, and members of the group using a picture phone operating without the meeting application used to generate the meeting request.

16. A method for providing management of mobile device originated meetings, the method comprising:
transmitting, by a computer system, a meeting request to a mobile device of each member of a group;
receiving, by the computer system, a response to the meeting request from a set of members from the group;
determining, by the computer system, a set of members from the group who have not responded to the meeting request; and
transmitting, by the computer system, the meeting request to the mobile device of each member of the group who has not responded to the meeting request.

17. The method according to claim 16, further comprising:
determining, by the computer system, an operating system and type of mobile device used by each member of the group; and
optimizing, by the computer system, the meeting request for each type of mobile device.

18. The method according to claim 17, the optimizing comprising:
determining, by the computer system, a method of communication configured for each type of mobile device; and
transmitting, by the computer system, the meeting request based on the method of communication configured for each type of mobile device.

19. The method according to claim 17, the determining comprising defining, by the computer system, the operating system and type of mobile device used by each member of the group as at least one of the following: a smart phone enabled with a meeting application used to generate the meeting request, a smart phone operating without the meeting application used to generate the meeting request, and a picture phone operating without the meeting application used to generate the meeting request.

20. The method according to claim 19 further comprising:
enabling, by the computer system, push-notification internet-based communication for members of the group using a smart phone enabled with the meeting application used to generate the meeting request; and
enabling, by the computer system, cellular-based communication for each of: members of the group using a smart phone operating without the meeting application used to generate the meeting request, and members of the group using a picture phone operating without the meeting application used to generate the meeting request.
